(19) United States
(12) Patent Application Publication
(10) Pub. No.: US 2009/0123607 A1
(43) Pub. Date: May 14, 2009

(54) Self-rising dough-containing food product and related manufacturing methods

(76) Inventors: John Brodie, Penndel, PA (US); Amr Shaheed, Howell, NJ (US)

Correspondence Address: MCCARTER & ENGLISH, LLP HARTFORD;CITYPLACE I, 185 ASYLUM STREET, HARTFORD, CT, 06103, US

(21) Appl. No.: 11/113,950

(22) Filed: Apr. 25, 2005

Related U.S. Application Data
(63) Continuation-in-part of application No. 10/754,867, filed on Jan. 9, 2004, now abandoned.

(51) Int. Cl. A21D 10/02; A21D 8/02; A21D 2/08

(52) U.S. Cl. 426/62; 426/551; 426/95; 426/504; 426/442; 426/502

(57) ABSTRACT

A self-rising dough-containing food product, particularly pizza, in which a non-yeast containing leavening system is combined with an uncooked dough in the presence of a moisture retention agent and dough conditioners to provide a frozen raw food product that may be cooked directly from the freezer in a microwave oven. The dough in the self-rising dough containing food product reaches full development in shorter mixing times at lower mixing speeds than conventional dough-containing products.

### CROSS-REFERENCE TO RELATED APPLICATION

The present application is a continuation-in-part application claiming the benefit of a co-pending non-provisional patent application entitled “Self-Rising Dough-Containing Food Product,” which was filed on Jan. 9, 2004 and assigned Ser. No. 10/754,867. The entire contents of the foregoing non-provisional patent application are incorporated herein by reference.

### FIELD OF THE INVENTION

The present invention is directed to self-rising dough-containing food products and related methods. The disclosed food products include at least one non-yeast containing leavening agent and can be made with or without yeast. The disclosed dough-containing food products incorporate a moisture retention agent and dough conditioners in an amount which enables the dough to reach full extensibility in short mixing times at low mixing speeds. The disclosed dough-containing food products are self-rising in the absence of yeast from a raw format and are particularly suited for heating directly from the freezer in a microwave oven. The food products of the present disclosure exhibit excellent organoleptic properties, including advantageous taste, chew, and mouth-feel properties.

### BACKGROUND OF THE INVENTION

Frozen food products which can be removed from a freezer and then immediately heated have become extremely popular food products. Such products are generally easy to prepare because they are removed from the freezer, heated, and served in a relatively short period of time without special preparations. Popular frozen food products of this type are those which can be heated in a microwave oven, particularly because microwave ovens have become readily available and are easy to use.

In order to provide a food product suitable for microwave cooking, it is known to pre-cook or pre-bake the food product and then to freeze the food product prior to packaging. For example, U.S. Pat. No. 4,283,424 discloses a frozen pizza product particularly adapted for cooking and/or reheating in a microwave oven. The frozen pizza product has a two element crust with the first crust element comprising a baked cracker-type dough material and the second crust element comprising a baked bread dough-type crust. Each of the crust elements is pre-baked prior to packaging the food product.

Prior art food products that are adapted for preparation by microwave cooking include yeast raised doughs. Food products containing yeast raised doughs are generally pre-baked, packaged in a frozen condition and then prepared for serving by heating in a microwave oven. Particular examples of such yeast raised dough containing food products include bakery products such as pizza. Pizza products contain yeast to provide a desirable texture. The yeast acts as a leavening agent and, upon heating, emits a sufficient amount of carbon dioxide to raise the dough to an acceptable level during pre-baking. The pre-baked product is then frozen and may then be microwaved or heated in an oven prior to serving.

U.S. Pat. No. 4,957,750 discloses leavened baked goods which, when warmed or heated in a microwave oven, retain their palatability. A protein-modifier is incorporated into the baked goods which is said to improve the texture of the product.

The step of pre-baking food products that are intended to be frozen and then heated in a conventional oven or a microwave oven, is a costly step in the preparation of the food product. Pre-baking expends significant sums of processing operation time and energy which adds to the cost of the food product. It would therefore be a significant advantage in the art of making frozen food products to eliminate the pre-baking step.

While yeast is an effective leavening agent, it is known that yeast tends to limit the shelf-life of a food product, typically to about two months. Frozen food products and other products may therefore have to be discarded prior to sale if the shelf-life is limited by the presence of yeast as a leavening agent. In recent years, chemical leavening agents have been incorporated into conventional frozen bakery products including frozen pizza. See Thomas A. Lehmann et al. Cereal Foods World, Vol. 25, No. 9 (September 1980) pp. 589-592; Lallemand Inc. Baking Update (1996); K. Skruland Baking Management (October 1998) pp. 40-41; and Thomas A. Lehmann, Am. Inst. Of Baking Vol. XIX (November 1997) pp. 1-6. Such chemical leavening systems require the generation of carbon dioxide and employ, for example, sodium bicarbonate as one of the components of the chemical leavening system along with a leavening acid, such as sodium aluminum phosphate, sodium acid pyrophosphate, and the like.

Dough formulations that contain a chemical leavening agent are typically pre-baked and frozen soon after forming. Under these circumstances, it is not uncommon for frozen pizza products to have a shelf-life up to and perhaps exceeding six months.

Although frozen bakery products have gained increasing acceptance in the marketplace, typical formulations are not suitable for heating in a microwave oven because the crust tends to become soggy and there is often uneven cooking. Therefore, frozen pizzas are typically baked in a conventional oven. Typical food preparation instructions for baking pizza in a conventional oven often require preheating the oven to a baking temperature of from about 350° F. to 450° F., which can take anywhere from about 5 to about 15 minutes depending on the oven. Furthermore, once the frozen pizza is placed in the oven, it often takes about 15 to about 30 minutes to cook the pizza, while microwave cooking, from freezer to fully cooked can typically be accomplished in significantly less time, for example from about 3 to about 7 minutes.

U.S. Publication No. 2002/0172747 discloses a self-rising dough-containing food product developed by the present inventors. The disclosed food product incorporates a non-yeast containing leavening system and a moisture retention agent to provide a frozen food product that may be cooked in a microwave oven. The principal leavening agents employed in the disclosed system were non-yeast containing leavening acids, such as a sodium aluminum phosphate leavening acid that was then-produced by Rhodia Inc. under the brand name LEVAIR. The disclosed self-rising dough product also optionally included a dough conditioner which served to break down the bonds of the dough and thereby make it softer. A preferred dough conditioner was sodium stearoyl lactylate, calcium sulphate and L-cysteine hydrochloride. Although the self rising dough containing product disclosed in the foregoing publication offered several advantages relative to prior art systems, the dough-containing product failed to satisfy additional needs and/or opportunities in the industry, e.g., reduced processing time for preparation of a dough with full extensibility.

U.S. Pat. No. 4,487,104 discloses an attempt to prepare a frozen dough with improved storage shelf-life which can be cooked in a microwave oven without pre-baking. The dough may employ a chemical leavening agent having a moisture content of from about 50% to about 95%, which is sufficient to prevent handling problems without adversely affecting extensibility of the dough. A moisture retention agent such as hydrocolloid gum is also used. The '104 patent further discloses that the dough may contain a dough conditioner, for example L-cysteine, in an amount of 0.60% by weight based on the total weight of the flour. Of particular importance to this dough is the use of wheat protein in an amount greater than 16% protein based on the total weight of the flour in which the dough is proofed before being frozen. The dough ingredients are mixed at a low speed for three minutes and a high speed for five minutes in order to provide sufficient extensibility to the dough for freezing and eventual cooking.

A significant problem in preparing doughs of the type disclosed in U.S. Pat. No. 4,847,104 is the excessive time needed to obtain full development of the dough. Full development means that the flour protein is at full extensibility or that the maximum elasticity of the dough has been obtained and is generally regarded as a measure of the quality of gluten. The extensive development time is costly and adds significantly to the time needed to prepare a dough-containing food product suitable for microwave cooking.

It is therefore desirable to provide a frozen food product which has a commercially acceptable shelf-life and which does not have to be pre-baked. It is also desirable to provide a frozen food product which employs a chemical leavening agent and which can be heated in a microwave by the consumer. It is further desirable to provide a self-rising pizza dough which, if heated in a microwave, has similar organoleptic and texture properties to conventional oven baked pizza products. It is additionally desirable to provide a frozen food product which may be heated in a microwave by the consumer and which does not require pre-baking prior to packaging. It is also desirable to provide a frozen food product in which the manner the dough achieves full development is superior to conventional dough-containing food products, e.g., more efficient and cost effective.

### SUMMARY OF THE INVENTION

The present invention is generally directed to a self-rising dough-containing food product in which the dough reaches full development/extensibility in shorter mixing times and at lower mixing speeds than conventional dough-containing products. The dough-containing food product of the present invention does not require pre-baking and eliminates yeast as a principal or exclusive leavening agent. The disclosed food products can be frozen and stored for extended periods of time and can be cooked using conventional and/or microwave ovens. The resulting food products have desirable texture and organoleptic properties, e.g., texture and organoleptic properties that are typically associated with pre-baked frozen food products and/or food-products that require cooking by a consumer in a conventional oven.

In a particular aspect of the present invention, there is provided a self-rising dough-containing food product comprising:

a) an uncooked dough-containing flour;

b) at least one non-yeast containing leavening agent;

c) a material capable of reacting with the non-yeast containing leavening agent to generate a sufficient amount of carbon dioxide to make the dough rise to a desirable level;

d) one or more dough conditioners present in an amount sufficient to enable the dough to reach full extensibility after mixing, wherein said mixing is performed for a short total mixing period at only low or medium speeds, and wherein said full extensibility is reached while the dough is at rest; and

e) an effective amount of a moisture retention agent to retain sufficient moisture in the disclosed dough during heating to provide the resulting heated product with desirable organoleptic properties, e.g., advantageous taste and chew properties.

In a further aspect of the invention, a method and/or technique for preparing an advantageous self-rising dough-containing product is provided in which full extensibility is achieved in relatively short mixing times and at low mixing speeds.

Additional features and functionalities of the disclosed self-rising dough-containing food product and associated methods for preparation thereof will be apparent from the detailed description which follows.

### DETAILED DESCRIPTION OF THE INVENTION

The self-rising dough containing food product of the present invention includes in part a conventional dough material which is not pre-cooked or pre-baked. Many of the components/ingredients of standard dough systems may generally be employed in preparing the self-rising dough products of the present invention. Typically, by way of example, the disclosed dough may be made from wheat flour, preferably high protein flour, non-fat milk solids (with the optional addition of soy protein concentrate), and other conventional additives. The composition of the dough may vary depending on the desired characteristics of the final product and/or processing/inventory considerations, as will be readily apparent to persons skilled in the art from the description herein.

In accordance with one aspect of the present invention, the constituents of the dough-containing food product include a target amount of dough conditioner. The presence of the dough conditioner as described herein facilitates the development of the dough during mixing so that full extensibility can be achieved in shorter mixing times and at lower mixing speeds than conventionally thought practicable. The reduction of mixing times and mixing speeds relative to conventional dough compositions and methods of forming dough-containing food products provides significant time and cost savings in the commercial preparation of such dough-containing food products without sacrificing the quality of the product.

In accordance with another aspect of the present invention, the disclosed dough material is provided with at least one non-yeast containing leavening agent as the principal leavening agent. In circumstances where at least one non-yeast leavening agent is employed in the disclosed dough-containing product, a reduced level of yeast may also optionally be employed in the formulation. The reduced yeast level (or complete elimination of yeast as a leavening agent) in the disclosed dough-containing products enables the dough-containing product to assume an extended shelf-life (e.g., six to twelve months), because the potential negative implications of yeast degradation in a relatively short period of time is significantly reduced or eliminated. Thus, a shelf-life of up to and exceeding one year is possible with the frozen food products of the present invention.

In general, the principal leavening agents employed in the present invention, and preferably the only leavening agents employed in the disclosed dough-containing products, are non-yeast containing leavening acids such as sodium aluminum phosphate in combination with a chemical synthesis of calcium acid pyrophosphate and monocalcium phosphate produced by Innophos, Inc. under the brand name DOUGH-RISE. For purposes of the chemical synthesis of calcium acid pyrophosphate and monocalcium phosphate, reference is made to a product commercially available from Innophos, Inc. under the brand name CALRISE, and commonly assigned U.S. Pat. Nos. 5,554,404; 5,667,836; 5,834,050; 5,925,397 and 6,080,441, the disclosures of which are incorporated herein by reference.

The disclosed leavening agent blends have unique and advantageous attributes when employed in the dough products of the present invention. For example, the disclosed leavening agent blends provide dual action and/or fulfill dual functionalities, by (i) effecting a desired level of leavening, and (ii) providing advantageous dough conditioning to the dough composition. The amount of the leavening agent for use in the present invention will typically be in the range of at least 0.40% based on the weight of flour and preferably from about 0.40% to 1.20% by weight based on the weight of the flour. Other non-yeast containing leavening agents which may be used in the present invention include calcium phosphate and sodium acid pyrophosphate.

The non-yeast containing leavening agents employed in the present invention react with a compound capable of generating carbon dioxide to enable the dough to rise to a desirable level. Desirable carbon dioxide generating compounds which react with the non-yeast containing leavening agents and that may be included in the disclosed dough compositions include sodium bicarbonate, potassium bicarbonate, and ammonium bicarbonate.

The dough-containing food product of the present invention also contains or includes a moisture retention agent which enables the food product to maintain a moisture content sufficient to provide a soft, desirable texture to the product after IS heating so as to provide excellent texture and organoleptic properties. Various food grade gums may be used for this purpose, including xanthan gum. A particularly preferred xanthan gum is commercially available from Danisco, Inc. under the brand name RHODIGEL ULTRA. The moisture retention agent is preferably employed in an amount of from about 0.05% by weight to about 0.135% by weight based on the total weight of flour present in the food product.

The present invention contains particular types of dough conditioners in a target amount which surprisingly has been found to provide significant advantages in the manner in which the dough is processed. Dough conditioners typically serve to break down the bonds of the dough and thereby make it softer. Dough conditioners are also known in the art as protein modifiers which are able to break the bonds of the gluten structure contained in a wheat product.

The dough conditioners employed in the present dough-containing product should be present in an amount sufficient to enable the dough constituents to be mixed for a shorter period of time and at slower mixing speeds than those employed for conventional dough-containing products. As noted above, the advantageous non-yeast containing leavening agents described herein function, at least in part, as a dough conditioner for purposes of the dough compositions of the present invention. A further dough conditioner is also advantageously employed, thereby contributing further to the dough conditioning functionality of the disclosed formulation and/or dough system.

As disclosed herein, the dough of the present invention advantageously reaches full extensibility after the short mixing time at slow mixing speeds over a wide range of subsequent resting times. As is well known in the art, mixing initiates the development of the dough. However, dough conditioning (which translates to the extensibility of the dough) continues after mixing has stopped and the dough remains at rest. The present dough-containing product provides greater extensibility as compared to conventional products over relatively short to long rest times.

Typically, the mixing speed employed in the present invention will be at least predominantly at a slow speed, with additional mixing at moderate or medium speeds, but in the absence of the high speed mixing. Thus, contrary to the teachings of U.S. Pat. No. 4,847,104 discussed above, the dough formulations and associated processing methods of the present disclosure eliminate the need for high speed mixing to achieve desired levels of extensibility.

In the dough forming art and for purposes of the present disclosure, a slow mixing speed is designated as Speed 1, a medium mixing speed is designated as Speed 2, and rapid or high mixing speed is designated as Speed 3. In prior art processes, high mixing speeds are used for a predominant amount of time, i.e., after an initial low mixing speed is used to initially blend the dough-forming constituents. By way of example, U.S. Pat. No. 4,847,104 (Example 14) discloses an initial three minute mixing period at low mixing speed (Speed 1) and a longer mixing period (five minutes) at high mixing speeds (Speed 3).

In accordance with the present invention, the disclosed dough-containing composition is formulated to be advantageously mixed at only low/medium mixing speeds and for shorter mixing periods than is taught in the prior art. The reduced mixing speeds and reduced mixing times advantageously reduce processing time, energy costs and manufacturing facility usage. Preferably, the total mixing period, including both low and optional medium mixing, will be no more than six (6) minutes and at least about three (3) minutes. For example, when only low speed mixing is used, mixing will typically be performed for up to about three (3) minutes. In cases where both low and medium speed mixing are used, preferred mixing rates are up to two (2) minutes for medium speed and up to two (2) minutes for low speed mixing. For example, a mixing period according to the present disclosure may include mixing for two (2) minutes at a low mixing speed and mixing for one and a half (1.5) minutes at a medium mixing speed. It should be noted that the preferred mixing times above are based on a Hobart mixer, but may vary depending on the mixing equipment used. However, regardless of mixer employed, the disclosed dough formulation possesses properties and/or characteristics that obviate the need for high speed mixing to achieve desired levels of extensibility.

The amount of dough conditioner incorporated into the dough formulation (independent of the dough conditioning functional contribution from the non-yeast containing leavening agents discussed above) is an important aspect of the present invention. A preferred amount of dough conditioner for incorporation into the dough-containing composition of the present disclosure is at least about 0.6% by weight based on the weight of the flour, preferably between about 0.65% by weight to about 1% by weight based on the weight of the flour, and more preferably about 0.75% by weight based on the weight of the flour. Of note and in distinct contrast to the present disclosure, lower amounts of dough conditioner, which may include L-cysteine or salts thereof, are disclosed for use in U.S. Pat. No. 4,847,104. However, these lower amounts of dough conditioner can not effectively achieve the objects of the present invention, e.g., desirable dough extensibility levels/properties despite reduced mixing times and lower mixing speeds.

A particularly preferred dough conditioner for use in exemplary dough compositions of the present invention is available from ADM Arkady under the trade name PANICRUST LC-K. The PANICRUST LC-K product contains L-cysteine hydrochloride, sodium stearoyl lactylate, and calcium sulfate. Alternative dough conditioners may be employed according to the present disclosure without departing from the spirit or scope of the present invention. In addition and as noted above, additional dough conditioning functionality is provided by the non-yeast leavening agents, e.g., DOUGH-RISE and/or CALRISE products, for purposes of the disclosed dough formulations.

Additional ingredients and/or components may be added to the dough formulations of the present disclosure. For example, increased fat levels may be incorporated into the dough formulations of the present disclosure, without departing from the spirit or scope hereof. Additional modifications, enhancements and/or component substitutions may be undertaken without departing from the present invention, as will be readily apparent to persons skilled in the art.

When making a frozen pizza product, it is also generally desirable to make the frozen product no greater than about ¼ inch thick, and preferably no greater than about ⅛ inch thick, in order to facilitate uniform heating of the frozen product, especially in a microwave oven.

In addition, heating of the frozen food product of the present invention in a microwave oven is best carried out by elevating the food product above the floor of the microwave oven. Susceptor disks commonly used in microwave ovens may be used for this purpose.

It should also be mentioned that, although dough-containing frozen food products of the present invention are suitable for microwave oven cooking, the frozen food products of the present invention may also be cooked using a conventional oven. It should also be understood that dough-containing frozen food products of the present invention may also be cooked using both a conventional oven and a microwave oven. Regardless of the form of cooking used, the frozen food products of the present invention exhibit improved characteristics relative to conventional dough-containing frozen food products.

### EXAMPLE 1

### Preparation of Self-Rising Pizza Product

The ingredients listed in Table 1 were employed to form a pizza product in accordance with the present invention.

TABLE 1

| Ingredients | Bakers % |
|---|---|
| Wheat Four | 100.00 |
| Non Fat Milk Solids | 2.50 |
| Defatted Soy Protein Concentrate | 2.07 |
| Dextrose | 2.00 |
| Salt | 1.79 |
| Olive Oil | 2.50 |
| Shortening, All Purpose | 2.25 |
| Baking Soda, Fine Granular | 0.81 |
| DOUGH-RISE (Brand Name) | 0.81 |
| (SALP, calcium Acid Pyrophospahte and | |
| Monocalcium phosphate) | |
| PANICRUST LC-K (Brand Name) | 0.75 |
| RHODIGEL ULTRA (Brand Name) | 0.09 |
| Water | 62.50 |
| Total | 178.07 |

A Hobart M-50 mixer equipped with a five quart bowl and dough hook was used to blend the dry ingredients set forth in Table 1 until all of the ingredients were well dispersed. To commence dough development, shortening (partly containing olive oil), oil and water were added to the vessel while mixing at low speed for two minutes. The ingredients were then mixed in the same vessel at a medium speed for one and a half minutes to produce a dough product.

### EXAMPLE 2

### Formation of Microwavable Pizza Product

The dough produced in accordance with Example 1 was formed into 150 g round samples (which is typically sufficient to form a ¼ inch thick pizza product having a diameter of 6 to 7 inches). The samples were allowed to remain at rest for 10 to 15 minutes. A roller was used to roll out the samples to a 7 inch diameter. The product was frozen and each frozen product was provided with 25 g of tomato sauce and 25 to 50 g of cheese. The entire product was frozen until all of the ingredients including the toppings were frozen and the frozen product was packaged and kept in the freezer.

### EXAMPLE 3

### Cooking Of Frozen Pizza Product

The frozen pizza product produced in Example 2 was placed on a susceptor disk and placed on a box in a microwave oven. The pizza product was cooked for 3½ to 4 minutes on full power and thereafter removed from the oven. The pizza product had desirable organoleptic properties, including taste, chew and mouth-feel.

Alternatively, the frozen pizza product can be placed in a conventional oven, with or without preheating, at a temperature of about 450° F. until the baking operation is complete.

### EXAMPLE 4

### Measurement of Extensibility of Doughs of the Present Invention Compared to a Control over a Range of Rest Times

The dry ingredients identified in Example 1 were blended as a dry mix. Thereafter, water, shortening and olive oil were added and the resulting mixture was mixed for two minutes at low speed and for 1½ minutes at medium speed.

The resulting dough was divided into 100 gram round samples and thereafter placed at rest for fifteen minutes. This dough was identified as Sample 1. Additional samples (Samples 2 and 3 and a control sample) were prepared in the same manner, except that Sample 2 was prepared using 0.50% of the PANICRUST LC-K dough conditioner and Sample 3 was prepared using 0.25% of the same dough conditioner. The control sample contained no dough conditioner (other than the dough conditioning contribution from the DOUGH-RISE product). Each of the samples was measured by a Kieffer Dough and Extensibility apparatus using a 5 kg load cell with the following settings: Measure force in Tension Return to start, 2.0 mm/s pre-test speed, 3.3 mm/s test speed, 10.0 mm/s post-test speed, 75 mm distance, auto 5-kg trigger force and 200 pps data acquisition rate.

The test results for the foregoing samples are shown in Table 2.

TABLE 2

| | Dough | | 5 MIN | 10 MIN | 15 MIN |
|---|---|---|---|---|---|
| | Conditioner | 0 MIN Rest | Rest | Rest | Rest |
| Sample 1 | 0.75% Dough | 24 mm* | 32 mm | 34 mm | 37 mm |
| | Conditioner | | | | |
| Sample 2 | 0.50% Dough | 24 mm | 26 mm | 28 mm | 29 mm |
| | Conditioner | | | | |
| Sample 3 | 0.25% Dough | 22 mm | 23 mm | 28 mm | 29 mm |
| | Conditioner | | | | |
| Control | 0% Dough | 24 mm | 22 mm | 24 mm | 26 mm |
| | Conditioner | | | | |

*Extensibility measured in mm.

The dough at zero time was underdeveloped and had little to no extensibility properties. Extensibility is an essential dough characteristic to permit processing of the dough into a finished product. As shown in Table 2, the samples of the dough containing compositions of the present invention (Samples 1-3) exhibited greater extensibility over the entire range of rest periods as compared to the control sample. In particular, as the dough rests up to the 15 minute time period, it gains a desired level of extensibility and exhibits very good machinability properties. Good machinability is critical to be able to process the dough further without appreciable shrinkage or snap back of the dough piece. As demonstrated in this Example, dough without a dough conditioner (as disclosed herein) will not exhibit acceptable levels of extensibility. Moreover, the advantageous extensibility levels were achieved in the samples prepared according to the present invention (Samples 1-3) despite the absence of high mixing speeds.

Although the present disclosure has been described with reference to exemplary embodiments and/or formulations of the disclosed self-rising dough-containing products, the present disclosure is not limited to such exemplary embodiments. Rather, the formulations and methods of the present disclosure are susceptible to many changes, variations, modifications and/or enhancements without departing from the present invention. For example, a variety of food products may be prepared using the dough products disclosed herein, e.g., non-pizza products, such as breadsticks, calzones and the like. The present invention expressly embraces such changes, variations, modifications and/or enhancements within its scope, as reflected in the scope of the patent claims set forth herein below.

1. A self-rising dough-containing food product comprising:
a) flour;
b) at least one non-yeast containing leavening agent in an amount between about 0.4% to 1.2% based on the weight of the flour;
c) a material capable of reacting with the non-yeast containing leavening agent to generate carbon dioxide;
d) a dough conditioner; and
e) a moisture retention agent;
wherein none of the non-yeast leavening agent or the material capable of reacting with the non-yeast leavening agent are encapsulated;
wherein said non-yeast containing leavening agent functions, at least in part, as a dough conditioner; and
wherein said non-yeast containing leavening agent and said dough conditioner are present in amounts effective to achieve full extensibility after mixing at one or more mixing speeds that are each less than high mixing speed.

2. The food product of claim 1 wherein said full extensibility is achieved after mixing and a period at rest.

3. The food product of claim 1 wherein said full extensibility is achieved after mixing at a low mixing speed and at a medium mixing speed.

4. The food product of claim 1 wherein mixing is undertaken for a total mixing period, and wherein said total mixing period is up to about six minutes.

5. The food product of claim 4 wherein said total mixing period is at least about three minutes.

6. The food product of claim 1 wherein said one or more mixing speeds includes low speed mixing and medium speed mixing.

7. The food product of claim 6 wherein mixing is undertaken for a total mixing period, and wherein said total mixing period comprises medium speed mixing for up to about two minutes and low speed mixing for up to about two minutes.

8. The food product of claim 6 wherein mixing is undertaken for a total mixing period, and wherein said total mixing period comprises low speed mixing for up to about two minutes and medium speed mixing for up to about 1½ minutes.

9. The food product of claim 1 wherein the dough conditioner comprises calcium sulfate.

10. The food product of claim 1 wherein the dough conditioner comprises calcium acid pyrophosphate and monocalcium phosphate

11. The food product of claim 1 wherein the dough conditioner comprises sodium stearoyl lactylate.

12. The food product of claim 1 wherein the dough conditioner comprises L-Cysteine.

13. The food product of claim 1 wherein the dough conditioner is in an amount that is at least about 0.60% by weight based on the weight of the flour.

14. The food product of claim 13 wherein the dough conditioner is in an amount between about 0.65% to about 1.5% by weight based on the weight of the flour.

15. The food product of claim 1 wherein the dough conditioner is in an amount that is about 0.75% by weight based on the weight of the flour.

16. The food product of claim 1 wherein the non-yeast containing leavening agent comprises a blend of sodium aluminum phosphate and a chemical synthesis of calcium acid pyrophosphate and monocalcium pyrophosphate.

17. The food product of claim 1 wherein the moisture retention agent is a gum.

18. The food product of claim 17 wherein the moisture retention agent is a xanthun gum.

19. The food product of claim 1 wherein the material capable of reacting with the non-yeast containing leavening agent is a bicarbonate.

20. The food product of claim 19 wherein the bicarbonate is a sodium bicarbonate.

21. The food product of claim 1 wherein said mixing defines a dough, and wherein full extensibility of said dough is reached while the dough is at rest.

22. The food product of claim 1 wherein the moisture retention agent is in an amount sufficient to retain a moisture level during heating so as to provide predetermined organoleptic properties.

23. The food product of claim 1 wherein said mixing defines a dough and wherein said dough is further processed to provide a frozen pizza.

24. The food product of claim 1 wherein said mixing defines a dough and wherein said dough is further processed to provide a food product that is microwavable.

25. The food product of claim 1 further comprising yeast.

26. The food product of claim 1 further comprising one or more components in an amount sufficient to increase the fat level.

27. A method of producing a self-rising dough-containing food product comprising:
a) combining ingredients comprising flour, a non-yeast containing leavening agent in an amount between about 0.4% to about 1.2% of the weight of the flour, a material capable of reacting with the leavening agent to generate carbon dioxide, a moisture retention agent and a dough conditioner, wherein none of the non-yeast leavening agent or the material capable of reacting with the non-yeast leavening agent are encapsulated;
b) mixing the ingredients for a mixing period and at one or more mixing speeds so as to define an uncooked dough, wherein said one or more mixing speeds are each less than high mixing speed;
c) allowing said uncooked dough to reach full extensibility while at rest; and
d) forming a food product from said uncooked dough.

28. The method of claim 27 wherein said non-yeast containing leavening agent functions, at least in part, as a dough conditioner.

29. The method of claim 28 wherein said non-yeast containing leavening agent and said dough conditioner are in an amount sufficient to enable the uncooked dough to reach full extensibility after mixing.

30. The method of claim 27 wherein said mixing is performed only at low or medium speeds.

31. The method of claim 27 wherein said mixing period is up to about six minutes.

32. The method of claim 31 wherein said mixing period is at least about three minutes.

33. The method of claim 27 wherein said mixing period includes mixing at low speed and mixing at medium speed.

34. The method of claim 33 wherein said mixing is performed for up to two minutes at said medium speed and for up to two minutes at said low speed.

35. The method of claim 33 wherein said mixing is performed at said low speed for up to about two minutes and at said medium speed for up to about 1½ minutes.

36. The method of claim 27 wherein said dough conditioner comprises calcium sulfate.

37. The method of claim 27 wherein said dough conditioner comprises sodium stearoyl lactylate.

38. The method of claim 27 wherein said dough conditioner comprises L-cysteine.

39. The method of claim 27 wherein said dough conditioner is at least about 0.60% by weight based on the weight of the flour.

40. The method of claim 27 wherein said dough conditioner is between about 0.65% to about 1% by weight based on the weight of the flour.

41. The method of claim 27 wherein said dough conditioner is about 0.75% by weight based on the weight of the flour.

42. The method of claim 27 further comprising heating said uncooked dough product in an oven.

43. The method of claim 27 further comprising heating said uncooked dough product in a microwave oven.

44. The method of claim 27 wherein said food product is in the form of a pizza.

45. The method of claim 27 wherein said food product is bread.

46. The method of claim 27 wherein said uncooked dough is a sweet dough.

47. The method of claim 27 further comprising freezing the uncooked dough product resulting from step (c) prior to forming said food product.
